(19) United States
(12) Patent Application Publication
(10) Pub. No.: US 2015/0026987 A1
(43) Pub. Date: Jan. 29, 2015

(54) Handle of Knife

(71) Applicant: YU-LIN CHIANG, Taipei City (TW)

(72) Inventor: YU-LIN CHIANG, Taipei City (TW)

(21) Appl. No.: 13/950,409

(22) Filed: Jul. 25, 2013

(51) Int. Cl. B26B 5/00

(52) U.S. Cl. CPC B26B 5/00
USPC 30/340

(57) ABSTRACT

An ergonomical handle of knife includes an upper side surface, a lower side surface and sidewalls coupling the upper side surface and the lower side surface. The lower side surface provides a force-acting portion positioned between two rest portions of the upper side surface, and at least one sidewall includes a bulge member. When a user holds the handle of knife with one hand, the palm of the hand is full of the bulge member to prevent the handle of knife from twisting when the knife is in operation. The arrangement of the force-acting portion and two rest portions enables the user operate the knife stably and steadily with less force.

### FIELD OF THE INVENTION

The present invention relates to a handle of knife, and more particularly to a handle of fixed knife.

### BACKGROUND OF THE INVENTION

The operation of a hand tool is executed by using fingers, palms, carpals and arms. A plurality of carpometacarpal joints construct a palm and joint to the radius and the ulna of a forearm. The configuration of carpometacarpal joint results in the motion of the wrist in two axes. The motion on the frontal plane is named ulnar deviation or radial deviation, the motion on the sagittal plane is named wrist flexion or extension.

Generally, the action angle of extension is about 75°-80°, the action angle of wrist flexion is about 85°-90°, the action angle of ulnar deviation is about 35°-37°, and the action angle of radial deviation is about 15°-20°. For occupations with hand tools in operation, a hand kept in wrong posture for a long time may be subject to cumulative trauma disorders.

US Patent Publication No. 20050115083 recites a knife with an ergonomic handle, which includes two separated positions near the cutting edge of a blade, and a hollow position together with a sidewall hollow portion away from the cutting edge of the blade. A user may rest the thumb of her/his hand in the hollow position and let a fore finger and a little finger rest in the separated positions. In operation, the handle is pressed downwards by the thenar muscle of the hand for the treatment of food ingredients, and kept in the stable way by enforcing the fore finger and the little finger upwards.

For weak or poorly steady users, such as elder people, all of the known handles of knives noted above may cause cumulative thumb injury because of poor stability of holding knife. Furthermore, when adapted to treat hard food ingredient, the known handle of the knife may be twisted within the user's hand to cause cutting damages.

Accordingly, hand tools in inadequate design may cause wrong postures in operation and further cause damage on the muscles or bones of hands or other accidents. So, it is necessary to have new handle designs for knives for user's operation in the stable, steady, and convenient ways.

### SUMMARY OF THE INVENTION

Accordingly, a handle of knife is provided herein, which includes one or more sidewalls with one or more bulge members. The bulge members are ergonomically adapted to full the palm of a hand when the handle of knife is held by the hand, so that the handle of knife is not twisted when it is in operation.

Accordingly, a handle of knife is provided to have an upper side surface and a lower side surface with different profiles. The arrangement of a force-acting portion of the lower side surface between two rest portions of the upper side surface enables a user operate the knife stably and steadily with less force.

Accordingly, a handle of knife is provided. The shape of the handle is advantageous for a hand in operation of knife with the handle to keep hands in the slight wrist extension at work for the reduction of cumulative trauma disorders on the hands.

Accordingly, a handle of knife, adapted to couple a blade includes a first side surface and a second side surface faced with each other and in stripe shapes; and two sidewalls connecting the first side surface and the second side surface, wherein one of the sidewalls comprises a bulge member, and when a user holds the handle with a palm full of the bulge member, in the case of a main axis of the handle of knife not parallel to a forearm jointed with the palm, an angle of wrist extension is not less than 20 degrees.

In a preferred embodiment, the angle of wrist extension is not more than 30 degrees.

In a preferred embodiment, the first side surface comprises a saddle, a plateau nearer the blade than the saddle, and a sloping ascending part from the saddle to the plateau, and the sloping ascending part is crossing over the bulge member and is not curving out of the bulge member.

In a preferred embodiment, the handle of knife further includes a first end between the sidewalls and the blade, and a free second end, the sidewalls positioned between the first end and the second end, when the second side surface corresponding to the bulge member is adapted to be set onto a plate, the first end is higher than the second end with respect to the plate.

In a preferred embodiment, the handle of knife further includes a first end between the sidewalls and the blade, and a free second end, the sidewalls positioned between the first end and the second end, wherein a top part of the bulge member is positioned nearer the first end than the second end, or near the second end than the first end, or equidistant from both the first end and the second end.

In a preferred embodiment, the top part of the bulge member is positioned nearer the first side surface than the second side surface, and the angle of wrist extension is not more than 30 degrees.

Accordingly, a handle of knife, adapted to couple a blade which has a cut edge and a spine, is provided herein. The handle of knife includes a first side surface and a second side surface faced with each other and in stripe shapes; a sidewall connecting the first side surface and the second side surface, and having a bulge member; and a first end jointing the blade and the sidewall, and the sidewall jointing the first end and a free second end, where in the case of the handle of knife adapted to be set onto a plate, with the second side surface corresponding to the bulge member, the first side surface corresponding to the first end is higher than the first side surface corresponding to the second end with respect to the plate.

In a preferred embodiment, the first side surface comprises a saddle, a plateau coupling the spine via the first end, and a sloping ascending part from the saddle to the plateau, and the sloping ascending part is crossing over the bulge member and is not curving out of the bulge member.

In a preferred embodiment, in the case of a palm adapted to be full of the bulge member and a main axis of the handle of knife not parallel to a forearm jointed with the palm, an angle of wrist extension is from 20 degrees to 30 degrees.

In a preferred embodiment, in the case of a user grasping the handle of knife with a hand, the position of the plateau is adapted to rest the thenar muscle zone of the hand, and the position of the saddle is adapted to rest the carpometacarpal joints of the hand with respect to a proximal phalanx of a fourth finger.

In a preferred embodiment, in the case of a user grasping the handle of knife with a hand, the palm of the hand is full of the bulge member, the second side surface corresponding to the bulge member is adapted to be held by a first, a second, a third and a fourth fingers.

In a preferred embodiment, in the case of a user grasping the handle of knife with a hand, the palm of the hand is full of the bulge member, and a top part of the bulge member is positioned nearer the first end than the second end, or nearer the second end than the first end, or equidistant from the first end and the second end.

In a preferred embodiment, the first side surface comprises a saddle, a plateau coupling the spine via the first end, and a sloping ascending part from the saddle to the plateau, the position of the plateau is adapted to rest the thenar muscle zone of the hand, the second side surface corresponding to the bulge member is adapted to be held by a first, a second, a third and a fourth fingers, and the position of the saddle is adapted to rest the carpometacarpal joints of the hand with respect to a proximal phalanx of a fourth finger.

Accordingly, a handle of knife adapted to couple a blade includes a first side surface and a second side surface faced with each other and in stripe shapes, wherein the first side surface comprises a saddle, a plateau, and a sloping ascending part from the saddle to the plateau; and a sidewall connecting the first side surface and the second side surface, and having a bulge member, wherein in the case of a user grasping the handle of knife with a hand, the position of the plateau is adapted to rest the thenar muscle zone of the hand and a thumb, the palm of the hand is full of the bulge member, the second side surface corresponding to the bulge member is adapted to be held by a first, a second, a third and a fourth fingers, and the position of the saddle is adapted to rest the carpometacarpal joints of the hand with respect to a proximal phalanx of a fourth finger.

In a preferred embodiment, in the case of a main axis of the handle of knife not parallel to a forearm jointed with the palm, an angle of wrist extension is from 20 degrees to 30 degrees.

In a preferred embodiment, the sloping ascending part is crossing over the bulge member and is not curving out of the bulge member.

In a preferred embodiment, the handle of knife further includes a first end between the sidewall and the blade, and a free second end, the sidewall positioned between the first end and the second end, wherein the first end is near the plateau, and the second end is near the saddle.

In a preferred embodiment, a top part of the bulge member is positioned nearer the first end than the second end, or near the second end than the first end, or equidistant from both the first end and the second end.

In a preferred embodiment, a top part of the bulge member is positioned nearer the sloping ascending part of the first side surface than the second side surface.

### BRIEF DESCRIPTION OF THE DRAWINGS

FIG. 1 is a drawing illustrating the bones of a right hand.

FIG. 2 is a drawing illustrating the palm of a right hand.

FIG. 3 is an exemplary side drawing illustrating a handle of knife according to an embodiment of the present application.

FIG. 4 is a sideview drawing illustrating holding the exemplary handle according to the present application.

FIG. 5 is a sideview drawing illustrating holding the exemplary handle according to the present application.

FIG. 6 is a sideview drawing illustrating the handle with the exemplary bulge member according to the present application.

FIG. 7 is a sideview drawing illustrating the handle with the exemplary bulge member according to the present application.

FIG. 8 is a sideview drawing illustrating the handle with the exemplary bulge member according to the present application.

FIG. 9 is an overlook view drawing illustrating the handle held by a user according to the present invention.

### DETAILED DESCRIPTION OF THE PREFERRED EMBODIMENT

In order to more fully understand the present invention, it is helpful to define background concepts and terminology. In accordance with the present invention, it is believed that the majority of existing handle of knife may be difficult and uncomfortable to use. Thus, the handle design for a knife in the present invention enables a user treat food ingredient in the stable and steady way.

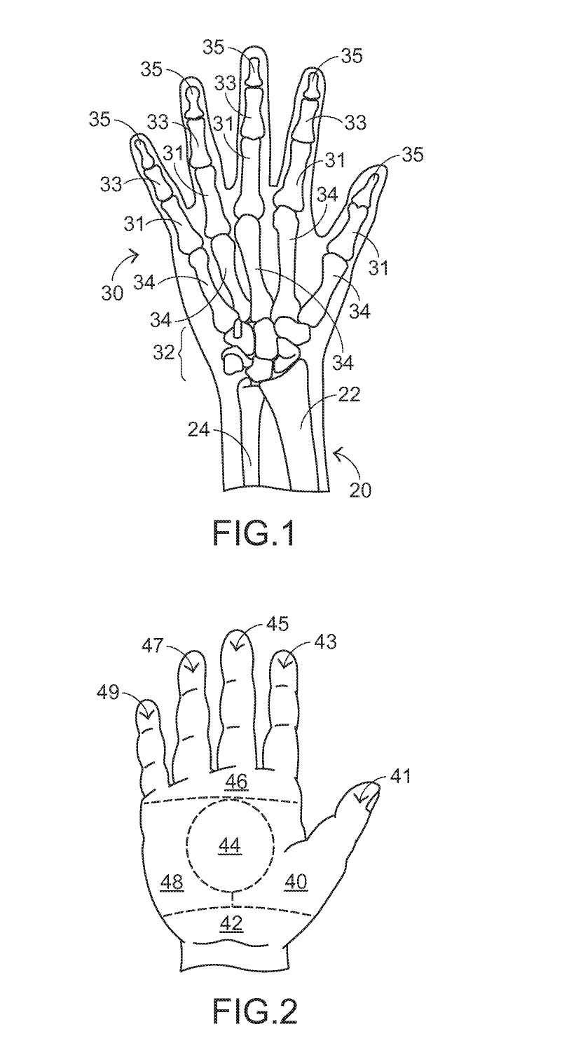

FIG. 1 and FIG. 2 are the drawings respectively illustrating the bones and palm of a right hand. Referring to FIG. 1, a user's forearm 20 includes a radius 22, a ulna 24, and a plurality of carpals 32 jointing both the radius 22 and the ulna 24 of the forearm 20 with five metacarpals 34 of a hand 30. The zone of the carpals 32 jointed with metacarpals 34 is carpometacarpal joint 36. Each metacarpal 34 joints to a proximal phalanx 31 for each finger, and each proximal phalanx 31 joints to a middle phalanx 33 or a distal phalanx 35.

Referring to FIG. 1 and FIG. 2, with respect to a palm side, the joint zone of the metacarpals 34 with the radius 22 and the ulna 24 is defined a lower palm zone 42. The portion of metacarpals 34 below the second finger 45 and the third finger 47 is defined a middle palm zone 44. The joint zone of the proximal phalanxs 31 of the first finger 43, the second finger 45, the third finger 47 and the fourth finger 49 with the metacarpals 34 is defined an upper plam zone 48. The portion of metacarpals 34 below the first finger 43 and the thumb 41, which includes first dorsal interosseous muscle, is named thenar muscle zone 40. The portion of metacarpals 34 below the fourth finger 49 is named hypothenar muscle zone 48.

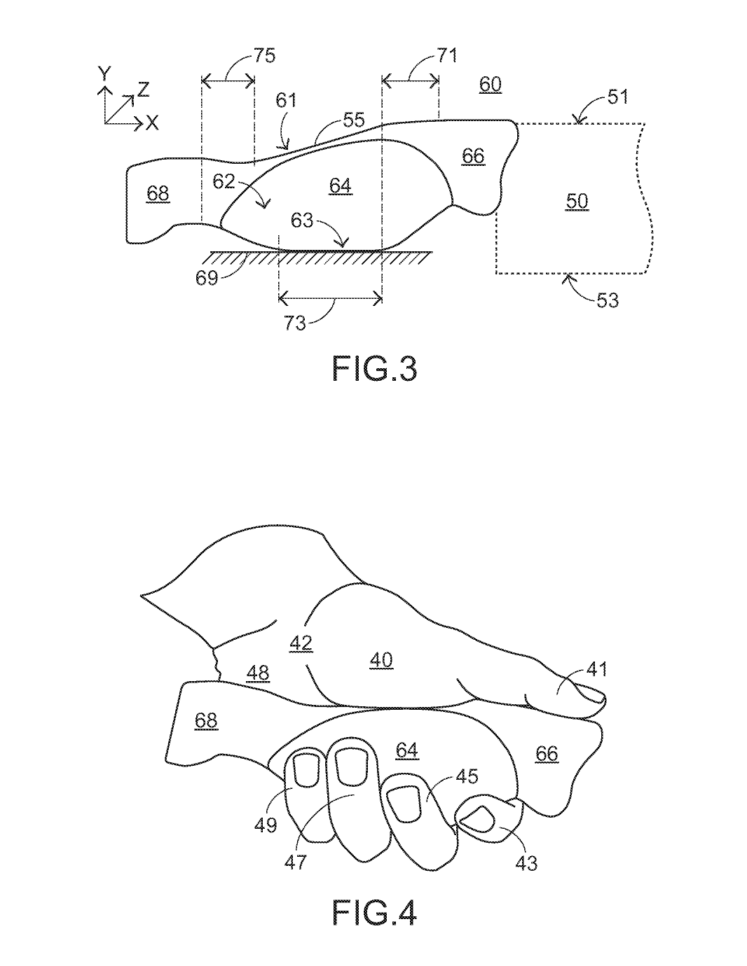

FIG. 3 is an exemplary side drawing illustrating a handle of knife according to an embodiment of the present application. Please refer to FIG. 3, a knife includes a handle 60 adapted to couple a blade 50, and the blade 50 has a cut edge 53 and a spine 51. In the case of operating the knife, the cut edge 53 is moved downwards for cutting or chopping ingredients, and the spine 51 is thicker edge for optional rest of a hand. It is noted that a blade 50 in huge volume is just for illustrating the use of the handle in the field of knifes in a kitchen, but not limited to one drew in FIG. 3.

Next, the handle 60 includes a first side surface 61 and a second side surface 63 faced with each other and in stripe shapes, and two sidewalls 62 connecting the first side surface 61 and the second side surface 63. One or two sidewalls 62 have respective bulge members 64 to couple a first end 66 and a second end 68 in the direction of main axis X of the handle 60. In one embodiment, the first end 66 is proximate the blade 50, while the second end 68 is free and away the blade 50. Besides, the first side surface 61, which has a curve surface with a profile, is next to the spine 51, and the second side surface 63 which is also a curve one with another profile is next to the cut edge 53. With regard to the handle 60, the second side surface 63 corresponding to the bulge member 64 is adapted to be set onto a plate 69, the first end 66 is higher than the second end 68 with respect to the plate 69. In the embodiment, the part of the second side surface 63 adapted to be set onto the plate 69 is substantially flat as a force-acting portion 73. The surface, from the force-acting portion 73 toward the first end 66 or the second end 68, is concave to the first side surface 61. Furthermore, the bulge member 64 has s top part in the direction of Z axis, and the top part is deposited between the first side surface 61 and the middle from the first side surface 61 and the second side surface 63.

With regard to the handle 60, the second side surface 63 corresponding to the bulge member 64 is adapted to be set onto the plate 69, the part of the first side surface 61 next to the first end 66 is higher than the part thereof next to the second end 68. That is, in the direction of the main axis X, the part of the first side surface 61 is sloping ascending from the second end 68 to the first end 66 and formed a sloping ascending part 55. The sloping ascending part 55 is substantially linear or concave to rather than convex out the force-acting portion 73. In the embodiment, the first side surface 61 provides two rest portions 71, 75 separated by the sloping ascending part 55. Furthermore, the rest portion 75 near the second end 68 includes the saddle of the first side surface 61, and the rest portion 71 near the first end 66 includes the plateau of the first side surface 61.

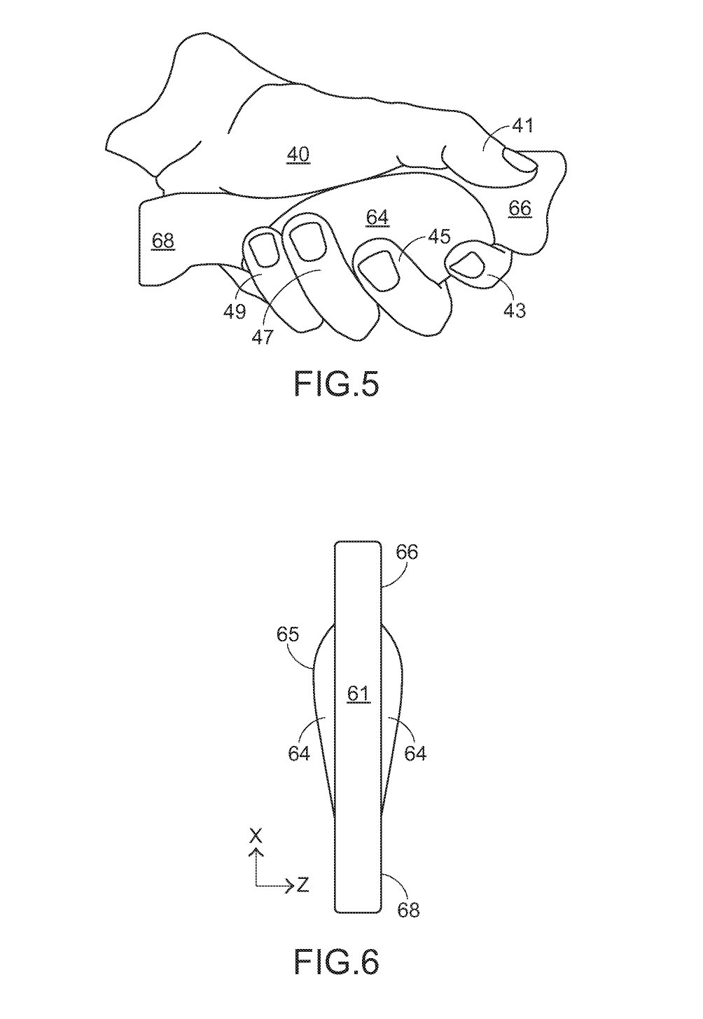

FIG. 4 and FIG. 5 are sideview drawings respectively illustrating holding the exemplary handle according to the present application. The handle grasped by a user is shown in FIG. 4, and one gripped by the user is shown in FIG. 5. Please refer to FIG. 3, FIG. 4 and FIG. 5, in the case of the handle 60 grasped or gripped by a hand of the user, the position of the sloping ascending part 55 of the first side surface 61 is adapted to rest and position the thenar muscle zone 40 of the hand. The thumb 41 and portion of the thenar muscle zone 40 in the grasping state may be rested onto the rest portion 71, while the portion of the thumb 41 in the gripping state may be rested onto the sidewall 62 close to the first end 66.

Furthermore, in the case of handle 60 grasped or gripped by the hand, the rest portion 75 is adapted to rest and position the carpometacarpal joints of the hand with respect to a proximal phalanx of a fourth finger, such as hypothenar muscle zone 48. The force-acting portion 73 of the second side surface 63, which is corresponding to the bulge member 64, is adapted to be held by the upper palm zone 46 (shown in FIG. 2), a first finger 43, a second finger 45, a third finger 47 and a fourth finger 49. Accordingly, when the user grasps or grips the handle 60, the user may operate the knife stably and steadily by resting the hand onto the rest portions 71, 75 cooperated with the upper palm zone 46, a first finger 43, a second finger 45, a third finger 47 and a fourth finger 49 holding the force-acting portion 73. Compared with the prior handle held in the way of one force-acting zone cooperated with two resting zone, the handle 60, grasped or gripped in the way of one force-acting portion 73 between two rest portions 71, 75, is advantageous for the user to stably and steadily hold the handle 60 with less force.

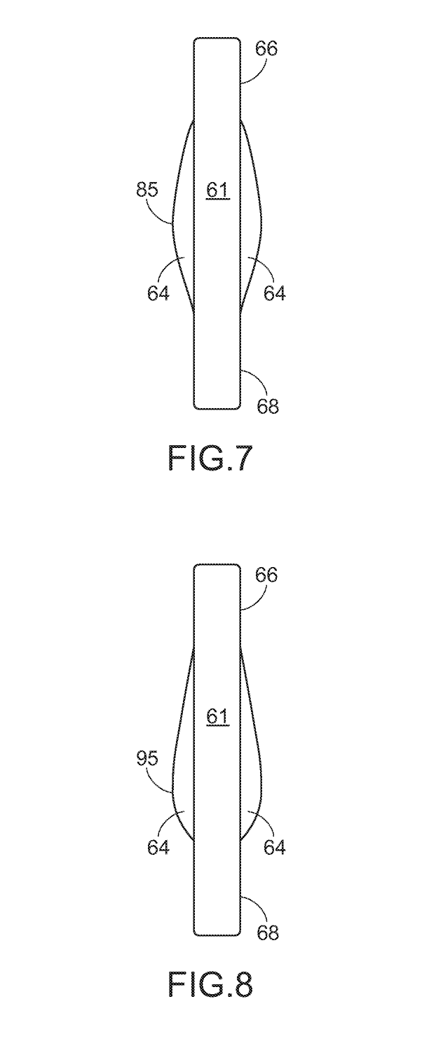

FIGS. 6, 7, 8 are sideview drawings respectively illustrating the handle with different bulge members according to different embodiments of the present application. With respect to the main axis X of the handle, any bulge member 64 is protruded out along with axis Z, and the farthest portion from the main axis X is named as a top part 65, 85 and 95. In the embodiments, with respect to the first end 66 and the second end 68, the top part 65 is closer to the first end 66 than to the second end 68 in FIG. 8, or a top part 85 is equidistant from both the first end 66 and the second end 68 in FIG. 7, or a top part 95 is nearer the second end 68 than the first end 66 in FIG. 8.

It is noted that the handle is described with each sidewall having a bulge member and two bulge members in pair. However, it is acceptable to have only one of two sidewalls with a bulge member, or two different bulge members in the present invention.

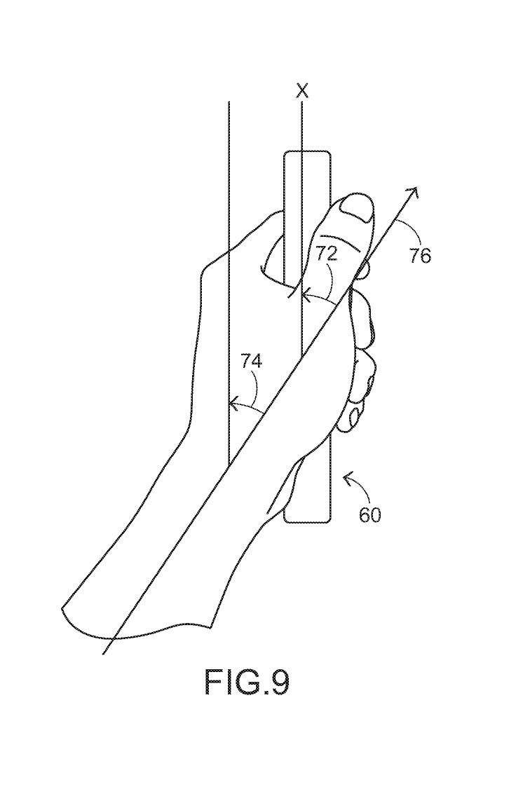

FIG. 9 is an overlook view drawing illustrating the handle held by a user according to the present invention. Referring to FIG. 9, with respect to a user's forearm as a reference level 76, in the case of the handle 60 held by the user, the angle 72 between the reference level 78 and the main axis X of the handle 60 is not zero, that is, the main axis X of the handle 60 is not parallel to the reference level 76. Next, the angle 74 of the wrist extension for the hand 60 is not less than 20°, because the user's middle palm zone 44 and the upper palm zone 46 is full of the bulge member 64 of the handle 60. In consideration of the stability of holding a knife, the handle 60 according to the present invention makes the angle 74 of the wrist extension is preferred from 20° to 30° to generate the best holding performance. It is advantageous for the user to treat hard ingredients with a knife equipped with the handle 60, because the handle 60 enables the palm of the hand be full of the bulge members 64 to prevent the handle 60 from twisting in the hand when the knife is in operation. The handle 60 cooperated with the profiles of the first side surface 61 and the second side surface 63 also enables the user more easily operate the knife.

It is understood that, in consideration of hands and fingers in various sizes, lengths and thickness, the palm full of the bulge members aforementioned may include only the middle palm zone, or the middle palm zone together with upper palm zone, or the middle palm zone together with upper palm zone and lower palm zone. Furthermore, in consideration of hands and fingers in various sizes, lengths and thickness, the ways of resting thenar muscle zone, hypothenar muscle zone or fingers may be a little different from the ways aforementioned. However, the arrangement of the force-acting portion between the two rest portions and one or more bulge members is benefic for the handle to be held in the stable and steady way and with use of less force.

An ergonomic handle of knife has been shown and described. From the foregoing, it will be appreciated that, although embodiments of the invention have been described herein for purposes of illustration, various modifications may be made without deviating from the spirit and scope of the invention. For example, although all features of the preferred embodiment described herein are believed to contribute to the improved ergonomic results of the present invention, modification or omission of an individual feature or features may be made and still gain benefits of the present invention.

What is claimed is:

1. A handle of knife, adapted to couple a blade, the handle of knife comprising:
a first side surface and a second side surface faced with each other and in stripe shapes; and
two sidewalls connecting the first side surface and the second side surface, wherein one of the sidewalls comprises a bulge member, and when a user holds the handle with a palm full of the bulge member, in the case of a main axis of the handle of knife not parallel to a forearm jointed with the palm, an angle of wrist extension is not less than 20 degrees.

2. A handle of knife according to claim 1, wherein the angle of wrist extension is not more than 30 degrees.

3. A handle of knife according to claim 1, wherein the first side surface comprises a saddle, a plateau nearer the blade than the saddle, and a sloping ascending part from the saddle to the plateau, and the sloping ascending part is crossing over the bulge member and is not curving out of the bulge member.

4. A handle of knife according to claim 3, further comprising a first end between the sidewalls and the blade, and a free second end, the sidewalls positioned between the first end and the second end, when the second side surface corresponding to the bulge member is adapted to be set onto a plate, the first end is higher than the second end with respect to the plate.

5. A handle of knife according to claim 1, further comprising a first end between the sidewalls and the blade, and a free second end, the sidewalls positioned between the first end and the second end, wherein a top part of the bulge member is positioned nearer the first end than the second end, or near the second end than the first end, or equidistant from both the first end and the second end.

6. A handle of knife according to claim 5, wherein the top part of the bulge member is positioned nearer the first side surface than the second side surface, and the angle of wrist extension is not more than 30 degrees.

7. A handle of knife, adapted to couple a blade which has a cut edge and a spine, the handle of knife comprising:
a first side surface and a second side surface faced with each other and in stripe shapes;
a sidewall connecting the first side surface and the second side surface, and having a bulge member; and
a first end jointing the blade and the sidewall, and the sidewall jointing the first end and a free second end, where in the case of the handle of knife adapted to be set onto a plate, with the second side surface corresponding to the bulge member, the first side surface corresponding to the first end is higher than the first side surface corresponding to the second end with respect to the plate.

8. A handle of knife according to claim 7, wherein the first side surface comprises a saddle, a plateau coupling the spine via the first end, and a sloping ascending part from the saddle to the plateau, and the sloping ascending part is crossing over the bulge member and is not curving out of the bulge member.

9. A handle of knife according to claim 8, wherein in the case of a palm adapted to be full of the bulge member and a main axis of the handle of knife not parallel to a forearm jointed with the palm, an angle of wrist extension is from 20 degrees to 30 degrees.

10. A handle of knife according to claim 8, wherein in the case of a user grasping the handle of knife with a hand, the position of the plateau is adapted to rest the thenar muscle zone of the hand, and the position of the saddle is adapted to rest the carpometacarpal joints of the hand with respect to a proximal phalanx of a fourth finger.

11. A handle of knife according to claim 7, wherein in the case of a user grasping the handle of knife with a hand, the palm of the hand is full of the bulge member, the second side surface corresponding to the bulge member is adapted to be held by a first, a second, a third and a fourth fingers.

12. A handle of knife according to claim 7, wherein in the case of a user grasping the handle of knife with a hand, the palm of the hand is full of the bulge member, and a top part of the bulge member is positioned nearer the first end than the second end, or nearer the second end than the first end, or equidistant from the first end and the second end.

13. A handle of knife according to claim 12, wherein the first side surface comprises a saddle, a plateau coupling the spine via the first end, and a sloping ascending part from the saddle to the plateau, the position of the plateau is adapted to rest the thenar muscle zone of the hand, the second side surface corresponding to the bulge member is adapted to be held by a first, a second, a third and a fourth fingers, and the position of the saddle is adapted to rest the carpometacarpal joints of the hand with respect to a proximal phalanx of a fourth finger.

14. A handle of knife, adapted to couple a blade, the handle of knife comprising:
a first side surface and a second side surface faced with each other and in stripe shapes, wherein the first side surface comprises a saddle, a plateau, and a sloping ascending part from the saddle to the plateau; and
a sidewall connecting the first side surface and the second side surface, and having a bulge member, wherein in the case of a user grasping the handle of knife with a hand, the position of the plateau is adapted to rest the thenar muscle zone of the hand and a thumb, the palm of the hand is full of the bulge member, the second side surface corresponding to the bulge member is adapted to be held by a first, a second, a third and a fourth fingers, and the position of the saddle is adapted to rest the carpometacarpal joints of the hand with respect to a proximal phalanx of a fourth finger.

15. A handle of knife according to claim 14, wherein in the case of a main axis of the handle of knife not parallel to a forearm jointed with the palm, an angle of wrist extension is from 20 degrees to 30 degrees.

16. A handle of knife according to claim 14, wherein the sloping ascending part is crossing over the bulge member and is not curving out of the bulge member.

17. A handle of knife according to claim 14, further comprising a first end between the sidewall and the blade, and a free second end, the sidewall positioned between the first end and the second end, wherein the first end is near the plateau, and the second end is near the saddle.

18. A handle of knife according to claim 17, wherein a top part of the bulge member is positioned nearer the first end than the second end, or near the second end than the first end, or equidistant from both the first end and the second end.

19. A handle of knife according to claim 17, wherein a top part of the bulge member is positioned nearer the sloping ascending part of the first side surface than the second side surface.
